(19) United States
(12) Patent Application Publication
(10) Pub. No.: US 2013/0054623 A1
(43) Pub. Date: Feb. 28, 2013

(54) Methods of Tagging an Image with a Database Keyword

(71) Applicant: Peichen Chang, Roseville, CA (US)

(72) Inventor: Peichen Chang, Roseville, CA (US)

(21) Appl. No.: 13/517,793

(22) Filed: Jun. 14, 2012

Related U.S. Application Data
(60) Provisional application No. 61/525,943, filed on Aug. 22, 2011.

(51) Int. Cl. G06F 17/30

(52) U.S. Cl. 707/752; 707/E17.104

(57) ABSTRACT

A computer-implemented method for tagging a database keyword to a data set or image file having the steps: initiating an act; recording a data set on an electronic device; transmitting the data set to a server; scanning the data set; scanning the database for database information that matches the data set; associating the database information that matches the data set with the matching data set; transmitting a database keyword associated with the database information to the electronic device; tagging the database keyword to a data set file; and imbedding the database keyword into an image file associated with the data set.

### CROSS-REFERENCE TO RELATED APPLICATION

This application claims the benefit of priority to U.S. Provisional Application No. 61/525,943, filed on Aug. 22, 2011, which is incorporated herein by reference in its entirety.

### BACKGROUND

Digital cameras and low cost storage enable photographers to capture and store a large number of images. The large number of images creates difficulty when organizing or sorting the images. Software tools have been developed to allow users to append or tag keywords to images, however, this tagging process is laborious and time consuming.

### SUMMARY OF THE INVENTION

The present disclosure pertains to a computer-implemented method for tagging a database keyword to a data set or image file, the method having: initiating an act; recording a data set on an electronic device; transmitting the data set to a server; and tagging a database keyword to a data set file. In another aspect, the computer implemented method has the step matching a data set with database information. In another aspect, the computer implemented method has the steps scanning the data set; scanning the database for database information that matches the data set; associating the database information that matches the data set with the matching data set; transmitting a database keyword associated with the database information to the electronic device; and tagging the database keyword to a data set file. In another aspect, the computer implemented method has the step imbedding the database keyword into an image file associated with the data set.

In another aspect, the computer implemented method has the step creating a user profile. In another aspect, the computer implemented method has the step transmitting the user profile to a server. In another aspect, the computer implemented method has the step decrypting the data set. In another aspect, the computer implemented method has the step electing a parameter. In another aspect, the computer implemented method has the step adding a location placeholder to the data set.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, where:

FIG. 1 is a block diagram of an electronic device according to an exemplary embodiment.

FIG. 2 is a flow chart of a process according to an exemplary embodiment.

FIG. 3 is a flow chart of a process according to an exemplary embodiment.

### DETAILED DESCRIPTION

To aid in understanding aspects of the invention described herein, some terms used in this description are defined below.

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure pertains to a system and method for tagging a database keyword to a data set or image file, for example, a photograph or video recording. A database keyword tagged to a data set or image file can be used by a user, such as a person who records the data set or image, to search for or categorize the image.

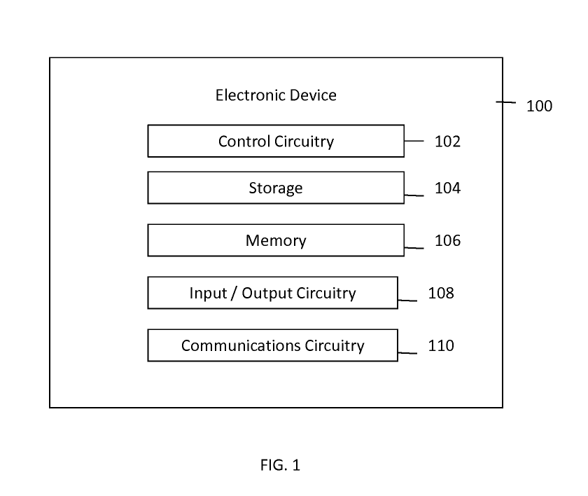

FIG. 1 shows an illustrative electronic device 100 for providing a device application for interfacing with a host. Electronic device 100 can include control circuitry 102, storage 104, memory 106, input/output (“I/O”) circuitry 108, and communications circuitry 110. In some embodiments, one or more of the components of the electronic device 100 can be combined or omitted (e.g., storage 104 and memory 106 may be combined). In some embodiments, the electronic device 100 can include other components not combined or included in those shown in FIG. 1 (e.g., a display), or several instances of the components shown in FIG. 1. Only one of each of the components is shown in FIG. 1.

The electronic device 100 can include any suitable type of electronic device 100. For example, the electronic device 100 can include a substantially fixed electronic device 100, such as a desktop computer. As another example, electronic device 100 can include a larger portable electronic device 100, such as a laptop or tablet computer. As another example, the electronic device 100 can include a portable electronic device 100 that the user may hold in his or her hand, such as a digital media player, a personal e-mail device, a personal data assistant (“PDA”), a cellular telephone, a handheld gaming device, or a digital camera. The electronic device 100 can be camera enabled allowing the user to capture a photograph or record a video.

Control circuitry 102 can include any processing circuitry or unit including a microprocessor, or processor operative to control the operations and performance of the electronic device 100. For example, control circuitry 102 can be used to run operating system applications, firmware applications, media playback applications, media editing applications, or any other application. In some embodiments, control circuitry 102 can drive a display and process inputs received from an interface.

Storage 104 can include, for example, one or more storage mediums including a hard-drive, solid state drive, flash memory, permanent memory such as ROM, any other suitable type of storage component, or any combination thereof. Storage 104 can store, for example, application data (e.g., for implementing functions on the electronic device 100), firmware, user profile (e.g., account information), image file, data set, authentication information (e.g. libraries of data associated with authorized users), and any other suitable data or any combination thereof.

Memory 106 can include cache memory 106, semi-permanent memory such as RAM, and/or one or more different types of memory 106 used for temporarily storing data. In some embodiments, memory 106 can also be used for storing data used to operate electronic device 100 applications, or any other type of data that can be stored in storage 104. In some embodiments, memory 106 and storage 104 can be combined as a single storage 104 medium. In some embodiments, memory 106 and storage 104 are coupled to the processing unit.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, for example, a button, keypad, mouse, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wireles sly).

In some embodiments, I/O circuitry 108 can include display circuitry (e.g., a screen or projection system) for providing a display visible to the user. For example, the display circuitry can include a screen (e.g., an LCD screen) that is incorporated into electronic device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within the electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device 100, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry 110 operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

Electronic device 100 can include one or more instances of communications circuitry 110 for simultaneously performing several communications operations using different communications networks, although only one is shown in FIG. 1. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

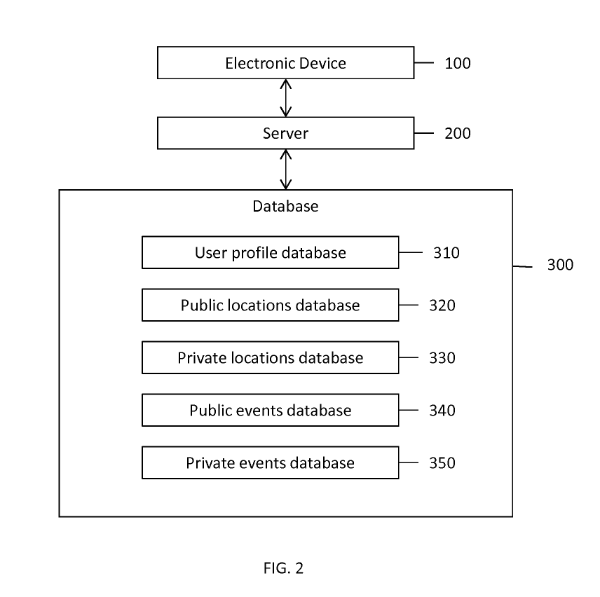

In one embodiment, the electronic device 100 may include a device application to interface with at least one server 200 thereby providing the electronic device 100 with the ability to create and present transmissions to a server 200. For example, as shown in FIG. 2, through the device application of the electronic device 100, the user can connect to a server 200, for example, a host server, website server, database server, or the like. The host server can be any server 200 that receives and transmits communication between the electronic device 100 and the host, the electronic device 100 and the database server, or the like. For example, the host server can receive communication from the host and transmit the communication to the electronic device 100. The database server can be any server 200 that allows for the storage of data. In one embodiment, the website server communicates directly with the electronic device 100. In one embodiment, the server 200 may include a server application to allow the server 200 to create and present transmissions to another server 200 or the electronic device 100.

As shown in FIG. 2, communication between the electronic device 100 and the host server, the electronic device 100 and the website server, the electronic device 100 and the database server, the host server and the database server, and the host server and the website server may be accomplished through any suitable network that may be provided by one or more communication interface, for example, WLAN, WAN, or LAN connection. Specifically, by way of example, the network may be a wireless internet connection established by way of the WLAN interface, a local area network connection established through the LAN interface, or a wide area network connection established by way of the WAN interface, which may include one of various WAN mobile communication protocols, such as a General Packet Radio Service (GPRS) connection, an EDGE connection (Enhanced Data rates for GSM Evolution connection), or a 3G connection, such as in accordance with the IMT-2000 standard. One or more of the data encryption techniques and security protocols (e.g., SSL or TSL protocols) may be further utilized in order to facilitate the secure transmission of the data (e.g. session information) from the electronic device 100 to the host server.

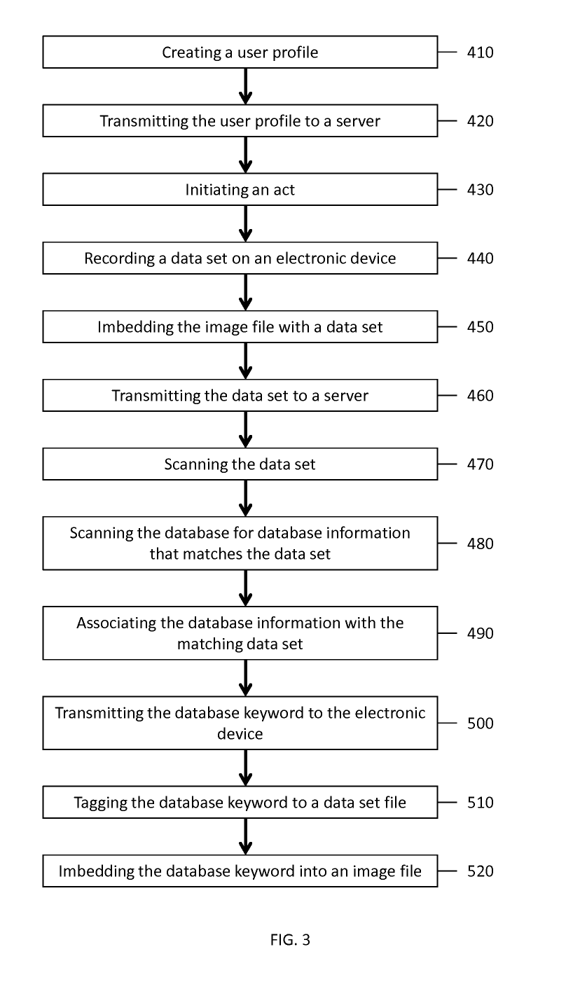

In one embodiment, as shown as block 410 in FIG. 3, the method has the step of creating a user profile. A user profile allows for the user to be associated with an image or a data set. A user profile is created by obtaining user information. User information can be a name, unique identifier, IP address, email address, password, phone number, mailing address, or the like. In one embodiment, the user information is obtained by allowing users to enter user information via a public web site or a mobile application.

Once a user profile is obtained, as shown as block 420 in FIG. 3, the user profile is transmitted to a server 200 and stored on the database 300, thereby allowing for the user profile to be retrieved at a future date. The database 300 may be local and/or may be remote with respect to the server 200. The database 300 can be, for example, without limitation, a MySQL database, XML files, or the like. In one embodiment, the database 300 has a user profile database 310. The user profile database 310 can be incorporated into a server 200 using scripting language. Scripting language can be, for example, PHP, ASP, JavaScript, HyperText Markup Language (HTML), or the like. The server 200 can be configured to receive information from an electronic device 100 or another server 200 and transmit information to an electronic device 100 or another server 200.

In one embodiment, as shown as block 430 in FIG. 3, the method has the step of initiating an act. An act can be capturing an image, checking-in at a location, or the like. All known methods of capturing an image utilizing an electronic device 100 are incorporated herein by reference. Checking-in means to declare publicly by posting a message onto a public, semi-public, or private message board and/or social networking site, such as Facebook, Twitter, Four-Square, or the like that the user is physically at a location, place of business, or the like.

In one embodiment, as shown as block 440 in FIG. 3, the method has the step of recording a data set on an electronic device 100. The data set or metadata can be any data associated with an act, for example, location name, event name, latitude and longitude coordinates, date, time, user profile, unique identifier, image keyword, copyright information, or the like. The location may be represented as textual name, latitude and longitude coordinates, and/or encrypted latitude and longitude coordinates. For example, the time an image was captured and the latitude and longitude coordinates of the location of the electronic device 100 when the image was captured can be recorded on an electronic device 100.

In one embodiment, as shown as block 450 in FIG. 3, where the method of initiating an act is capturing an image, the method has the step of imbedding the image file with a data set created upon capturing an image. In one embodiment, the device application is configured to imbed the image file associated with the image with a data set. The image file with the imbedded data set is stored on the electronic device 100 in storage 104.

In one embodiment, as shown as block 460 in FIG. 3, the method has the step of transmitting the data set to a server 200. In one embodiment, the device application transmits the data set to a server 200. For example, the device application submits a query to the server 200. The query may be formatted in a standard data format, for example, REST, XML, SQL, or the like. The query can include an image identifier, profile data, data set, processing directives, or the like. The processing directives are instructions for actions to be performed in relation to the information contained in the query or in the database 300, for example, to encrypt the data set in the query utilizing cipher-text, to store the data set contained into the database 300, to associate a database keyword with the data set or image file, to include a user defined text string from the user profile information, or the like.

In one embodiment, method has the step of decrypting the data set. In one embodiment, the data set is decrypted utilizing a decryption algorithm. All known methods of decrypting information are incorporated herein by reference, for example, the use of a unique key such as a user name or password associated with the user.

In one embodiment, the method has the step of tagging a database keyword to a data set file. In one embodiment, the database keyword is tagged to a data set file by matching a data set with database information. Database information and database keywords are associated together and stored on the database 300.

Database information can be any type of information associated with a location, event, or the like. In one embodiment, database information can have public locations information, private locations information, public events information, private events information, or any combination thereof. Public locations information can be any information associated with a public location, for example, geographical information such as geographic taxonomy, user identified unique identifier such as a globally unique variable length alpha-numeric string, geospatial boundary information such as latitude and longitude coordinates of at least three points allowing for the creation of a polygon, date ranges associate with geographic boundaries of political entities or legal jurisdictions, such as governments, sovereign states, federated states, and other subnational entities, words associated with a public location, name of a point of interest such as attractions, cities, parks, amusement centers, museums, zoos, restaurants, bars, night clubs, or the like, geographical features, or any combination thereof. Private locations information can be any information associated with a private location, for example, geographical information such as geographic taxonomy, user identified unique identifier such as “Home”, geospatial boundary information such as latitude and longitude coordinates of at least three points allowing for the creation of a polygon, date ranges associate with geographic boundaries of political entities or legal jurisdictions, such as governments, sovereign states, federated states, and other subnational entities, words associated with a private location, name of the owner of a private location, or any combination thereof.

Public events information can be any information associated with a public event, for example, unique identifiers, words associated with a public event, recurrence interval such as annually, date and/or time associated with or during a public event, holidays, or any combination thereof. Private events information can be any information associated with a private event, for example, unique identifiers, words associated with a private event, recurrence interval such as annually, date and/or time associated with or during a public event, or any combination thereof.

In one embodiment, where the database 300 has database information that includes public locations information or private locations information and the data set does not include information pertaining to location, a location placeholder, for example, the word “Earth” is added to the data set.

A database keyword can be any word used to identify a public location, private location, public event, private event, or the like.

In one embodiment, the method has the step of electing a parameter thereby allowing the image file or data set to be tagged with a desired database keyword. Stated another way, by electing a parameter, an undesired database keyword is prevented from being tagged to the image file or data set. A parameter can be any means of categorizing a plurality of database keywords, for example, the parameter can be religious holidays with database keywords associated with a specific religion, language with database keywords associated with a specific language, location with database keywords associated with the types of geographic boundaries of political entities or legal jurisdictions (e.g. countries, states, counties, cities, or the like), culture with database keywords associated with a specific culture, or the like. The electing parameters can be performed upon creating a user profile or can be incorporated into a query by way of a processing directive.

In one embodiment, the database 300 is configured to have a public locations database 320, private locations database 330, public events database 340, private events database 350, or any combination thereof. In one embodiment, each public locations database 320, private locations database 330, public events database 340, and private events database 350 is located on a separate server 200.

The public locations database 320 has public locations information associated with a database keyword. The public locations database 320 is created by obtaining public locations information with associated database keywords from entities providing data warehouses, performing a public locations information query of data warehouses that store public locations information, allowing individuals to enter public locations information via a public web site or a mobile application, or any combination thereof. Data warehouses can be any storage mechanism for storing information about a public location, for example, public and private databases, search engines, report agencies, data aggregators, online directories, or the like. A public locations information query can be performed by an API, web query, or SQL request. The public locations information is transmitted to a server 200 and stored on the public locations database 320.

The private locations database 330 has private locations information associated with a database keyword. The private locations database 330 is created by allowing individuals to enter public locations information and associated database keywords via a public web site or a mobile application, transmitting the information to a server 200, and storing the information on the private locations database 330.

The public events database 340 has public events information associated with a database keyword. The public events database 340 is created by obtaining public events information with associated database keywords from event organizers, ticket agencies, event sponsors, online event directories, data aggregators, or the like, performing a public locations information query of data warehouses that store public events information, allowing individuals to enter public events information via a public web site or a mobile application, or any combination thereof. Data warehouses can be any storage mechanism for storing information about a public event, for example, public and private databases, search engines, report agencies, data aggregators, online directories, or the like. A public events information query can be performed by an API, web query, or SQL request. The information is transmitted to a server 200 and stored on the public events database 340.

The private events database 350 has private events information associated with a database keyword. The private events database 350 is created by allowing individuals to enter private events information and associated database keywords via a public web site, mobile application, or links to a calendaring tool, transmitting the information to a server 200, and storing the information on the private events database 350.

In one embodiment, the database 300 is configured to have a public locations database 320, private locations database 330, public events database 340, private events database 350, or any combination thereof. In one embodiment, each public locations database 320, private locations database 330, public events database 340, and private events database 350 is located on an individual server 200.

In one embodiment, as shown as block 470 in FIG. 3, the method has the step of scanning the data set (i.e. the query). In one embodiment, as shown as block 480 in FIG. 3, the database 300 is scanned for database information that matches the data set. In one embodiment, the database 300, for example, the public locations database 320, private locations database 330, public events database 340, private events database 350, or any combination thereof, is scanned for database information that matches the data set. In one embodiment, as shown as block 490 in FIG. 3, the database information that matches the data set is associated with the matching data set. In one embodiment, as shown as block 500 in FIG. 3, the database keyword associated with the database information is transmitted to the electronic device 100 and, as shown as block 510 in FIG. 3, the data set file is tagged with the database keyword. In one embodiment, as shown as block 520 in FIG. 3, where the method has the step of capturing an image, database keyword is imbedded into the image file associated with the data set. In one embodiment, the server application scans the received query for a data set, scans the database 300 for database information, determines a match of the recognized data set with the database information, transmits the database keyword associated with the database information to the electronic device 100, imbeds the database keyword associated with the database information to the data set, and/or imbeds the keyword into the image file.

For example, where the data set associated with an image file includes 38°35′29.86″N, 121°25′57.48″W, the database information is public locations information such as 38°35′29.86″N, 121°25′57.48″W, and the database keyword is “California Exposition & State Fair,” the server application scans the received query and recognizes 38°35′29.86″N, 121°25′57.48″W, scans the public locations database 320 for 38°35′29.86″N, 121° 25′57.48″W, determines a match of the 38°35′29.86″N, 121°25′57.48″W in the query with the 38°35′29.86″N, 121°25′57.48″W in the public locations database 320, and transmits the database keyword “California Exposition & State Fair” associated with the database information to the electronic device 100. The device application imbeds the database keyword “California Exposition & State Fair” into the image file, thereby tagging the image file with the database keyword “California Exposition & State Fair.”

By way of another example, where the data set is 26°19′52.09″N, 127°45′17.26″E, the database information is private locations information such as 26°19′52.09″N, 127°45′17.26″E, and the database keyword is “Home”, the server application scans the received query and recognizes 26°19′52.09″N, 127°45′17.26″E, scans the private locations database 330 for 26°19′52.09″N, 127°45′17.26″E, determines a match of the 26°19′52.09″N, 127°45′17.26″E in the query with the 26°19′52.09″N, 127°45′17.26″E in the private locations database 330, and transmits the database keyword “Home” associated with the database information to the electronic device 100. The device application imbeds the database keyword “Home” to the data set, thereby tagging the data set with the database keyword “Home.”

By way of another example, where the data set associated with an image file is “Reno-Stead Airport, Reno, Nev.” and the start date and time of a public event, the database information is public events information “Reno-Stead Airport, Reno, Nev.” and the start date and time of a public event, and the database keyword is “Reno Air Races”, the server application scans the received query and recognizes “Reno-Stead Airport, Reno, Nev.” and the start date and time of the public event, scans the public events database 340 for “Reno Air Races” and the start date and time of the public event, determines a match of the “Reno-Stead Airport, Reno, Nev.” and the start date and time of the public event in the query with “Reno-Stead Airport, Reno, Nev.” and the start date and time of the public event in the private locations database 330, and transmits the database keyword “Reno Air Races” associated with the database information to the electronic device 100. The device application imbeds the database keyword “Reno Air Races” into the image file, thereby tagging the image file with the database keyword “Reno Air Races”.

By way of another example, where the data set is “Birthday” and May 1 at 8:00 PM, the database information is private events information “Birthday” and May 1 at 8:00 PM, and the database keyword is “Tyler's Birthday,” the server application scans the received query and recognizes “Birthday” and May 1 at 8:00 PM, scans the private event database 350 for “Birthday” and May 1 at 8:00 PM, determines a match of the “Birthday” and May 1 at 8:00 PM in the query with “Birthday” and May 1 at 8:00 PM in the private locations database 330, and transmits the database keyword “Tyler's Birthday” associated with the database information to the electronic device 100. The device application imbeds the keyword “Tyler's Birthday” to the data set, thereby tagging the data set with the database keyword “Tyler's Birthday.”

In one embodiment, the method has the step of preventing the image file from being tagged with multiple substantially identical keywords. Upon matching the recognized data set with database information, if the database keyword associated with the database information is substantially identical to the image keyword, the database keyword is not transmitted to the electronic device 100, thereby preventing the image file from being tagged with multiple substantially identical keywords.

For example, if the data set associated with an image is 38°35′29.86″N, 121°25′57.48″W and image keyword “California Exposition & State Fair,” the database information is public locations information such as 38°35′29.86″N, 121°25′57.48″W, and the database keyword is “California Exposition & State Fair,” the server application scans the received query and recognizes 38°35′29.86″N, 121°25′57.48″W and image keyword “California Exposition & State Fair,” scans the public locations database 320 for 38°35′29.86″N, 121°25′57.48″W, determines a match of the image keyword “California Exposition & State Fair” with the database keyword “California Exposition & State Fair,” but does not transmit the database keyword “California Exposition & State Fair” associated with the database information to the electronic device 100, thereby preventing the image file from being tagged as “California Exposition & State Fair, California Exposition & State Fair.”

In one embodiment, the method has the step of storing the data set and/or image file on the electronic device 100 in storage 104.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A computer-implemented method for tagging a database keyword to a data set or image file using a microprocessor, the method comprising:
initiating an act;
recording a data set on an electronic device;
transmitting the data set to a server; and
tagging a database keyword to a data set file.

2. The method of claim 1 wherein initiating an act comprises capturing an image.

3. The method of claim 2 wherein the image file is imbedded with a data set.

4. The method of claim 1 wherein initiating an act comprises checking-in at a location.

5. The method of claim 1 wherein tagging a database keyword to a data set file comprises matching a data set with database information.

6. The method of claim 5 wherein matching a data set with database information comprises:
scanning the data set;
scanning the database for database information that matches the data set;
associating the database information that matches the data set with the matching data set;
transmitting a database keyword associated with the database information to the electronic device; and
tagging the database keyword to a data set file.

7. The method of claim 6 further comprising imbedding the database keyword into an image file associated with the data set.

8. The method of claim 5 wherein the database information comprises public locations information, private locations information, public events information, and private events information.

9. The method of claim 5 wherein the database information is stored on a database.

10. The method of claim 9 wherein the database comprises public locations database, private locations database, public events database, and private events database.

11. The method of claim 1 further comprising creating a user profile.

12. The method of claim 11 further comprising transmitting the user profile to a server.

13. The method of claim 1 further comprising decrypting the data set.

14. The method of claim 1 further comprising electing a parameter.

15. The method of claim 1 further comprising adding a location placeholder to the data set.
